(19) United States
(12) Patent Application Publication
(10) Pub. No.: US 2006/0225721 A1
(43) Pub. Date: Oct. 12, 2006

(54) Convertible angle glass grinder or saw

(75) Inventors: Robert W. Baumbach, Sylmar, CA (US); Stuart Mackie, Whittier, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Gryphon Corporation, Sylmar, CA (US)

(21) Appl. No.: 11/388,230

(22) Filed: Mar. 22, 2006

Related U.S. Application Data
(60) Provisional application No. 60/666,323, filed on Mar. 29, 2005.

(51) Int. Cl. B28D 1/04

(52) U.S. Cl. 125/13.01

(57) ABSTRACT

A glass grinder or saw arrangement that includes a work surface that may tilt at an angle relative to the floor or surface on which the arrangement rests. Additionally, the arrangement also includes a pump for providing coolant to the grinder bit. The pump, in one aspect, is operably coupled to a motor for the glass grinder and recirculates water from an internal water tray to a diamond tool by means of tubing. The pump is powered by the motor and thus, turns off when the grinding head is turned off. Alternatively, a separate pump or a gravity water system, such as a tower that is in use with current grinders, may be provided in place of the motor-controlled pump. Adjustable feet may be used to adjust the tilt angle and/or a rotatable base portion may be rotated to obtain the tilt angle.

### CROSS-REFERENCES TO RELATED APPLICATIONS

This application claims priority to U.S. Provisional Patent Application No. 60/666,323, filed Mar. 29, 2005, the disclosure of which is hereby incorporated by reference herein in its entirety for all purposes.

### BACKGROUND OF THE INVENTION

1. Field of the Invention

The present invention relates to glass grinders and glass saws and, more particularly, to glass grinders and glass saws that include a work surface that may be placed or tilted at an angle relative to the surface on which the grinder or saw rests.

2. Description of the Prior Art

Glass grinders use a small diamond coated cylinder that rotates at high speed in order to grind glass or other hard material. The grinding bit typically comprises diamonds and is typically approximately one inch in diameter. The diamond bit needs to be cooled by water as it grinds. A work surface around the bit allows the user to place the glass or other material on a work surface for support in order to keep the glass perpendicular to the diamond surface of the bit. The user pushes the glass into the spinning diamond bit in order to grind or cut the glass.

Current glass grinders have a table that serves as the work surface and is perfectly horizontal. Thus, in order to use a glass grinder, an operator must generally stand. Additionally, the diamond bits require water for cooling. This water is usually supplied by a gravity feed or by wicking action of a sponge. A primary reason that glass grinders have a horizontal (parallel to the floor) work surface, is that water for cooling is held below the work surface and is fed to the diamond bit by either sponge wicking or gravity action. Also, standing in front of a glass grinder for use is not always convenient nor is it always comfortable. Many users, particularly elderly people, would prefer to sit, but the horizontal work surface makes it very difficult to see what one is doing while seated.

It is, therefore, desirable to provide glass grinders or saws that overcome the above and other problems.

### BRIEF SUMMARY OF THE INVENTION

The present invention provides a glass grinder or saw that includes a work surface such that the work surface may tilt at an angle relative to the floor. Additionally, the present invention provides a pump that is operably coupled to a motor, e.g., attached to a rear end of a motor, for the glass grinder and recirculates water from an internal water tray to a diamond tool by means of tubing. The pump is powered by the motor and thus, turns off when the grinding head is turned off. A gravity water system, such as a tower that is in use with current grinders, may be provided in place of the pump. Alternatively, a separate pump, that is not operably coupled to the motor may be used.

According to one aspect, a glass grinder or saw arrangement is provided that typically includes a motor, a work tool coupled to the motor and a work surface that tilts at an angle relative to a horizontal surface on which the arrangement rests. In certain aspects, the arrangement includes a pump operably coupled to the motor. In other aspects, the arrangement includes a pump that is controlled separately from the motor. In certain aspects, the work tool includes a diamond grinding bit or a diamond saw blade. In certain aspects, the arrangement includes an accessory wedge having an angle that is adjustable or non adjustable. In other aspects, the arrangement includes one or more feet having a length that is adjustable or non-adjustable. In certain aspects, the arrangement includes a base having an angled lower portion that is rotatable relative to a complementary top portion, whereby rotation of the top portion relative to the bottom portion provides an adjustable, angled work surface.

Other features and advantages of the present invention will be apparent upon review of the following detailed description of preferred exemplary embodiments.

### BRIEF DESCRIPTION OF THE DRAWINGS

FIG. 1 is a schematic of a glass grinder or saw arrangement in accordance with the present invention; and

FIG. 2 is a schematic illustration of the glass grinder or saw illustrated in FIG. 1 in a tilted position.

FIG. 3 is a schematic illustration of the glass grinder or saw with a rear foot that allows the apparatus to be placed in a tilted position.

FIG. 4 is a schematic illustration of the glass grinder or saw with a wedge that allows the apparatus to be placed in a tilted position.

### DETAILED DESCRIPTION OF THE INVENTION

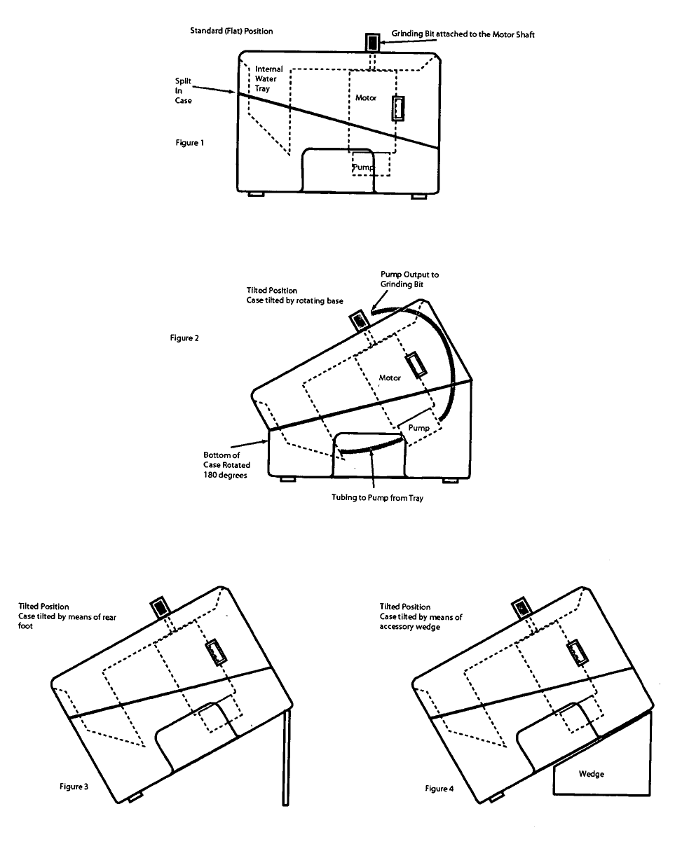

FIG. 1 illustrates a glass grinder or saw that includes a diamond tool in the form of a bit or saw blade. The arrangement is constructed to allow the table or work surface to be positioned at one of two or more angles. This is accomplished, in one aspect, by having a base that may be repositioned in order to vary the tilt of the work surface. In one embodiment as shown in FIGS. 1 and 2, the work surface or motor is tilted by providing a split in a base surrounding the grinder arrangement. The base may then rotated as may be seen in FIG. 2, thus placing the work surface and grinder at an angle relative to the ground or surface on which the base rests.

Alternatively or additionally, the base may also be tilted by other means, such as, for example, adjustable feet or by including an accessory wedge that is placed under the grinder arrangement. FIG. 3 is a schematic illustration of the glass grinder or saw with a rear foot that allows the apparatus to be placed in a tilted position. The rear foot in one aspect includes a mechanism for adjusting the length to provide an adjustable tilt to the work surface. Additionally or alternatively, the base may have a fixed, preset tilt, e.g., using nonadjustable feet. FIG. 4 is a schematic illustration of the glass grinder or saw with a wedge that allows the apparatus to be placed in a tilted position. The wedge may have a fixed tilt, or it may have an adjustable tilt.

In order to provide cooling water (or other coolant) to the diamond tool, a positive delivery system is preferably included that is independent of device orientation. The positive delivery system includes, in a preferred embodiment, a pump and a water storage tray as shown in FIGS. 1-4. However, a water tower may be provided that provides water by gravity forces to the diamond tool.

In a preferred embodiment, the pump is operably coupled to the motor such that when the motor for the grinding tool is turned off, the pump ceases operation. Likewise, when the motor is running, the pump provides water to the diamond tool. A pump that is not operably coupled to the motor may also be used. In this case, a separate pump control element, e.g., switch, may be provided for selectively activating the pump mechanism.

In a preferred embodiment, the work surface may be tilted at an angle up to approximately sixty (60) degrees relative to the surface on which the grinder arrangement is resting.

Thus, the present invention provides a grinder or saw arrangement that includes a tilted work surface. The tilt of the work surface may be adjustable (e.g., from 0° to about 60° or greater relative to the support surface), or preset and fixed. Allowing the work surface angle to be adjusted enables the user to select a position that is comfortable and provides good visibility.

Furthermore, in one aspect, the invention provides a pump that is driven by the same motor as the grinding tool, and provides consistent and reliable coolant flow to the grinding tool.

Allowing the adjustable angle for the work surface allows the operator to select the desired and appropriate angle for the desired job and environment. Also, if the grinder is used by multiple operators, each may have a preference as to the angle to be used and mayt adjust the tilt angle accordingly.

The built-in pump provides a larger and more consistent flow of water to the diamond tool, resulting in longer tool life and greater operator safety due to the reduction of glass dust during operation of the grinder arrangement.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. For example, the embodiments disclosed herein are applicable to saws and grinders other than glass saws and grinders, as well as other tools useful for processing glass or other materials. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A glass grinder or saw arrangement comprising a motor, a work tool coupled to the motor and a work surface that tilts at an angle relative to a surface on which the arrangement rests.

2. An arrangement in accordance with claim 1, further comprising a pump operably coupled to the motor.

3. An arrangement in accordance with claim 1, further including a separate pump that is controlled separate from the motor.

4. An arrangement in accordance with claim 1, further comprising an accessory wedge that is placed under the arrangement in order to tilt the work surface.

5. An arrangement in accordance with claim 1, further comprising adjustable feet.

6. An arrangement in accordance with claim 1, further comprising nonadjustable feet.

7. An arrangement in accordance with claim 1, wherein the angle is adjustable.

8. An arrangement in accordance with claim 1, wherein the angle is not adjustable.

9. An arrangement in accordance with claim 1, wherein the angle is less than about 60°.

10. An arrangement in accordance with claim 1, further comprising a base that houses the arrangement, wherein a top portion of the base is rotatable relative to a bottom portion of the base to thereby tilt the work surface.

11. An arrangement in accordance with claim 1, wherein the surface on which the arrangement rests is substantially horizontal.

12. An arrangement in accordance with claim 1, wherein the work tool includes a diamond grinding bit.

13. An arrangement in accordance with claim 1, wherein the work tool includes a diamond blade.
